(19) United States
(12) Patent Application Publication
(10) Pub. No.: US 2024/0092556 A1
(43) Pub. Date: Mar. 21, 2024

(54) FOLDING CONTAINER

(71) Applicant: THE MERVEILLE COMPANY, INC., Broomfield, CO (US)

(72) Inventor: Debra JONES, Nederland, CO (US)

(73) Assignee: THE MERVEILLE COMPANY, INC., Broomfield, CO (US)

(21) Appl. No.: 18/273,146

(22) PCT Filed: Feb. 1, 2022
(86) PCT No.: PCT/US2022/014733

§ 371 Date: Jul. 19, 2023

Related U.S. Application Data
(60) Provisional application No. 63/144,797, filed on Feb. 2, 2021.

(51) Int. Cl. B65D 81/32; B65D 51/16; B65D 51/24

(52) U.S. Cl. CPC B65D 81/3205; B65D 51/1644; B65D 51/246

(57) ABSTRACT

A container (100) is provided comprising a junction member (200). A first compartment (300) has a silicone first compartment storage portion (302), and a first compartment band (304) positioned around a mouth end (306) of the first compartment storage portion (302), wherein the mouth end (306) comprises a mouth lip (310) configured to be sealingly retained between a junction member planar portion (202) and the first compartment band (304). The first compartment storage portion (302) is configured to be folded about one or more thin sections of silicone (316) to fit within a volume of the junction member band portion (204) when the first compartment (300) is coupled to the junction member (200). A second compartment (400) has a lid (402) and a base (404), wherein the second compartment (400) is slidingly couplable to the junction member (200), and wherein the second compartment (400) is couplable to the junction member rail (222).

### TECHNICAL FIELD

The present Application is directed towards containers, and more particularly, to folding containers.

### BACKGROUND

Businesses and consumers are trying find solutions to reduce waste from food packaging and find sustainable solutions. Plastic is often the material of choice in food packaging because it's lightweight, durable, and easy to manufacture. Every year, however, the world produces 400 million tons of plastic. More than 40% of the plastic trash generated is single-use, and it can stay in our environment for hundreds of years. Moreover, consumers are also increasingly becoming aware that chemicals can leech into food when plastic comes into contact with food.

Other consumers may not like the aesthetics of the typical rigid plastic food container. Plastic food containers can scratch and stain, especially when food is heated and eaten out of them directly. Rigid plastic containers can take up a lot of room when ported around in a backpack or a shoulder bag. Plastic containers can break when dropped. Finally, not all plastic is dishwasher or microwave safe.

Silicone is a safer option for food containers because it does not leech chemicals into food. Silicone that can be heated in a microwave and washed in a dishwasher safely. Due to the flexible nature of silicon, however, it can be tricky to build food containers out of it.

Prior food containers incorporating silicone often repurpose plastic container designs, removing the bottom plastic bowl portion and replacing it with silicone bowls that can be folded up when not in use. To facilitate orderly folds in the silicone, prior designs used a stepped profile in silicone material having a relatively uniform thickness of 0.4-0.7 mm. The stepped profile silicone bowls created eating containers that rapidly become narrower towards the bottom of the container, which in many cases is not an ideal container format for consumers to eat out of.

Prior silicone container bowls do not feel sturdy, especially when the containers have large pleats.

Some prior foldable silicone containers collapse too easily or are awkward to refold, and this is also often attributable to pleated sides.

Finally, silicone is also a very expensive material to manufacture from. This may be one of the reasons that prior silicone container bowls incorporate so much plastic into their designs.

What is needed is a foldable silicone food container that incorporates less plastic, minimizes contact between plastic and food, feels solid, is compact when folded, flexible to use, has attachable utensils that to not take up space reserved for food, is less expensive, is microwavable, and is elegant in design.

### SUMMARY

A container is provided according to an embodiment. The container comprises a junction member comprising a junction member planar portion surrounded on a periphery by a junction member band portion, the junction member band portion comprising a junction member rail projecting from the junction member band portion. A first compartment comprises a first compartment storage portion comprising silicone with a mouth end and a bottom end, and a first compartment band positioned around the mouth end of the first compartment storage portion, wherein the mouth end comprises a mouth lip configured to be sealingly retained between the junction member planar portion and the first compartment band, and wherein the first compartment storage portion is configured to be folded about one or more thin sections of silicone such that the first compartment fits within a volume of the junction member band portion when the first compartment is coupled to the junction member. A second compartment comprises a lid and a base, wherein the second compartment is slidingly couplable to the junction member, and wherein the second compartment is couplable to the junction member rail.

A tool container configured to hold tools is provided according to an embodiment. The tool container comprises a body portion, a lid portion engageable to the body portion, and an elastic member configured to secure the lid portion to the body portion. The body portion and the lid portion each comprise a perimeter channel that provides a slot that captures the elastic member such that the elastic member cannot slide off the closed tool container without being stretched out of the perimeter channel.

A method to fabricate a container is provided according to an embodiment. The method comprises the step of providing the junction member comprising the junction member planar portion surrounded on the periphery by the junction member band portion, the junction member band portion further comprising the junction member rail projecting from the junction member band portion. The method further comprises the step of providing the first compartment comprising the first compartment storage portion comprising silicone with the mouth end and the bottom end, and the first compartment band positioned around the mouth end of the first compartment storage portion, wherein the mouth end comprises the mouth lip configured to be sealingly retained between the junction member planar portion and the first compartment band, and wherein the first compartment storage portion being is configured to be folded about one or more thin sections of silicone such that the first compartment fits within a volume of the junction member band portion when the first compartment is couplable to the junction member. The method further comprises the step of coupling the junction member and the first compartment together.

### Aspects

According to an aspect a container comprises a junction member comprising a junction member planar portion surrounded on a periphery by a junction member band portion, the junction member band portion comprising a junction member rail projecting from the junction member band portion. A first compartment comprises a first compartment storage portion comprising silicone with a mouth end and a bottom end, and a first compartment band positioned around the mouth end of the first compartment storage portion, wherein the mouth end comprises a mouth lip configured to be sealingly retained between the junction member planar portion and the first compartment band, and wherein the first compartment storage portion is configured to be folded about one or more thin sections of silicone such that the first compartment fits within a volume of the junction member band portion when the first compartment is coupled to the junction member. A second compartment comprises a lid and a base, wherein the second compartment is slidingly couplable to the junction member, and wherein the second compartment is couplable to the junction member rail.

Preferably, the lid wraps around the edge of the base.

Preferably, the junction member rail frictionally engages both the lid and the base of the second compartment to couple the second compartment to the junction member.

Preferably, the lid of the second compartment is configured to be removable from the base and is further configured for use as a bowl.

Preferably, the first compartment band is couplable to the junction member.

Preferably, the first compartment band is formed from a material that is stiffer than the first compartment storage portion.

Preferably, the first compartment band is threadingly couplable to the junction member.

Preferably, the junction member comprises a valve configured to be in an open and closed position, wherein the valve allows allowing pressure equalization between the first compartment storage portion and an external environment when in the open position.

According to an aspect, a tool container is configured to hold tools and comprises a body portion, a lid portion engageable to the body portion, and an elastic member configured to secure the lid portion to the body portion. The body portion and the lid portion each comprise a perimeter channel that provides a slot that captures the elastic member such that the elastic member cannot slide off the closed tool container without being stretched out of the perimeter channel.

Preferably, the tools comprise a primary tool and one or more secondary tools, wherein the primary tool further comprises an engagement region configured to engage and secure one or more secondary tools thereto.

Preferably, the elastic member comprises a size and dimension such that it is configured to attach the tool container to the container claimed in claim 1 by wrapping around both the tool container and the container.

Preferably, the primary tool comprises at least one of a fork, spoon, knife, and a spork, and the one or more secondary tools comprises at least one of a fork, spoon, knife, spork, and chopsticks.

Preferably, the elastic member comprises an indentation, and the body portion comprises a boss engageable to the indentation to aid in securing the elastic member in the perimeter channel.

According to an aspect, a method to fabricate a container is provided that comprises the step of providing the junction member comprising the junction member planar portion surrounded on the periphery by the junction member band portion, the junction member band portion further comprising the junction member rail projecting from the junction member band portion. The method further comprises the step of providing the first compartment comprising the first compartment storage portion comprising silicone with the mouth end and the bottom end, and the first compartment band positioned around the mouth end of the first compartment storage portion, wherein the mouth end comprises the mouth lip configured to be sealingly retained between the junction member planar portion and the first compartment band, and wherein the first compartment storage portion being is configured to be folded about one or more thin sections of silicone such that the first compartment fits within a volume of the junction member band portion when the first compartment is couplable to the junction member. The method further comprises the step of coupling the junction member and the first compartment together.

Preferably, the method further comprises the steps of providing a second compartment comprising a lid and a base and slidingly coupling the second compartment to the junction member.

Preferably, the method further comprises the step of attaching the tool container to the container, using the elastic member.

### BRIEF DESCRIPTION OF THE DRAWINGS

The same reference number represents the same element on all drawings. The drawings are not necessarily to scale.

FIG. 1 depicts a container, in accordance with an embodiment;

FIG. 2 depicts a container of FIG. 1 in a folded conformation, in accordance with an embodiment;

FIG. 3 depicts a container, with a second compartment partially slidingly disengaged, in accordance with an embodiment;

FIG. 4 depicts a second compartment with a lid partially removed therefrom, in accordance with an embodiment;

FIG. 5 depicts a junction member and valve, in accordance with an embodiment;

FIG. 6 depicts a partial cross-sectional view of the container, in accordance with an embodiment;

FIG. 7 depicts a junction member disengaged from a first compartment, in accordance with an embodiment;

FIG. 8 depicts a tool container, in accordance with an embodiment;

FIG. 9 depicts a tool container, in accordance with an embodiment;

FIG. 10 depicts the portions of a tool container, in accordance with an embodiment;

FIG. 11 depicts a tool container coupled to a container, in accordance with an embodiment;

FIG. 12 depicts a method 500 in accordance with an embodiment.

### DETAILED DESCRIPTION

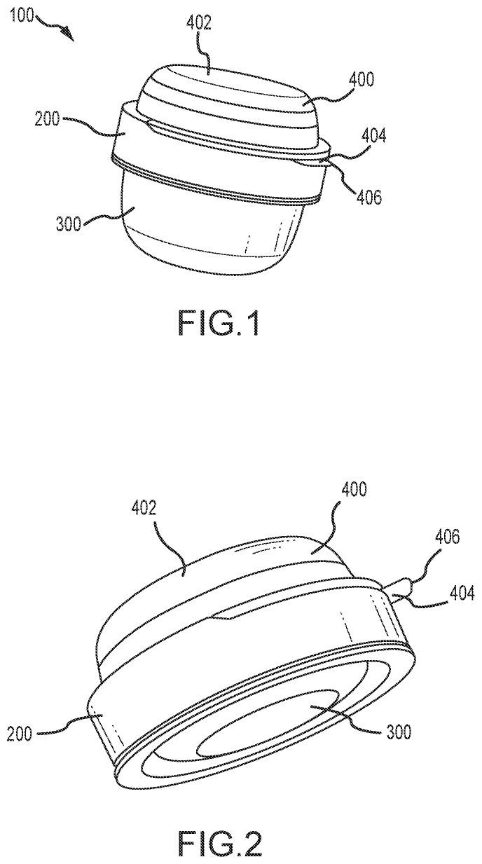

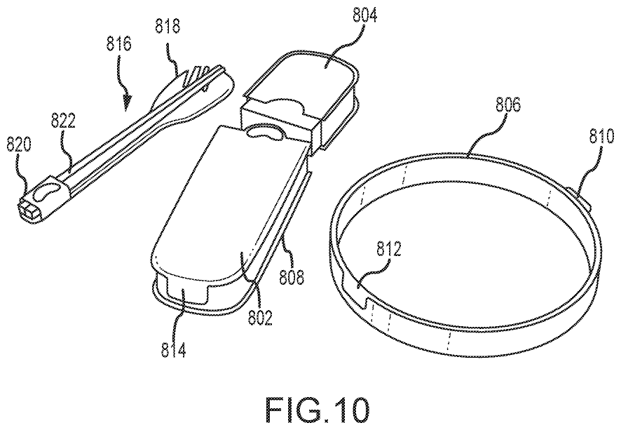

FIGS. 1-12 and the following description depict specific examples to teach those skilled in the art how to make and use the best mode of the Application. For the purpose of teaching inventive principles, some conventional aspects have been simplified or omitted. Those skilled in the art will appreciate variations from these examples that fall within the scope of the Application. Those skilled in the art will appreciate that the features described below may be combined in various ways to form multiple variations of the Application. As a result, the Application is not limited to the specific examples described below, but only by the claims and their equivalents.

FIG. 1 depicts a container 100 in accordance with an embodiment. The container 100 may be used to hold or store any item. In embodiments, container 100 may be used to store food. In embodiments, container 100 may be used to store food for a meal or food for multiple meals or snacks for an individual for a day.

Container 100 comprises a junction member 200 and a first compartment 300. Junction member 200 that may be used to seal first compartment 300. First compartment 300 may be used to store any item or material, such as food. FIG. 1 depicts a perspective view of the container 100, while FIG. 2 depicts a perspective view of the container 100 in a folded conformation.

In embodiments, container 100 may further comprise a second compartment 400. Second compartment 400 may be used to store any item or material, much like first compartment 300. In embodiments, second compartment 400 may be used to store food.

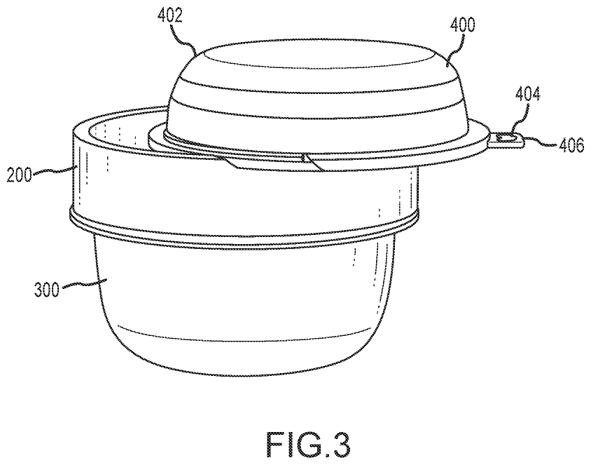

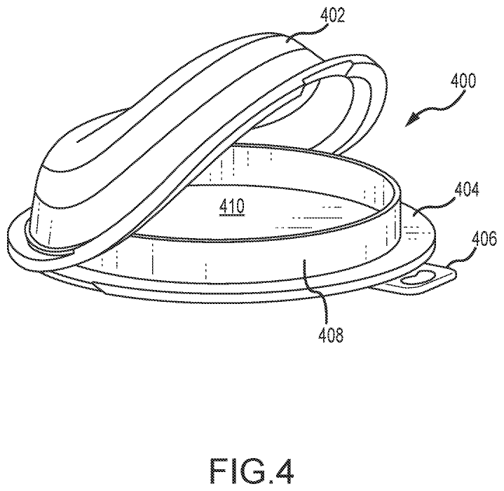

FIG. 3 illustrates the second compartment 400 partially slidingly disengaged from the junction member 200. FIG. 4 further illustrates that the second compartment 400 comprises a lid 402 and a base 404. The base 404 may comprise a tab 406 that allows a user to engage the base 404 to facilitate disengagement from the junction member 200. In an embodiment, the lid 402 is made of a soft material that may be stretched to frictionally engage the base 404. In an embodiment, the lid 402 comprises silicone. The second compartment 400 may be operable to store any item, for example any food item, and may be configured as a tray. The base 404 comprises a perimeter wall 408 that forms a container 410 that may be used to store any item or material. Additionally, the lid 402 may be inverted, after removal from the base 404, and used as a shallow bowl to contain any item or material.

In embodiments, lid 402 may be configured to seal closed the second compartment 400. In embodiments, lid 402 may be configured to seat around a periphery of the base 404. For example, as may be seen in FIG. 4, the lid 402 wraps around the edge of the base 404.

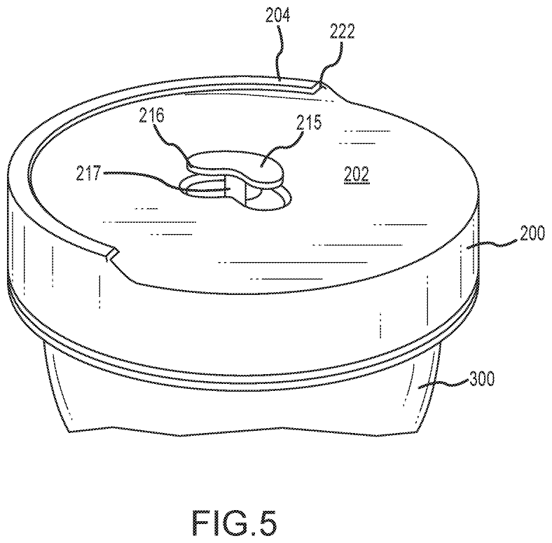

FIG. 5 shows the junction member 200 comprises a junction member planar portion 202. Junction member planar portion 202 is at least partially surrounded around a periphery by a junction member band portion 204. In embodiments, junction member 200 may further comprise a junction member rail 222 positioned proximate the junction member band portion 204. In embodiments, junction member rail 222 may comprise any structure operable to couple to the second compartment 400. In embodiments, junction member rail 222 may surround at least a portion of a circumference of the junction member band portion 204 and be configured to engage either the lid 402, the base 404, or both the lid 402 and base 404 of the second compartment 400 when second compartment 400 is inserted into junction member rail 222 via a sliding motion. This is illustrated in FIG. 3.

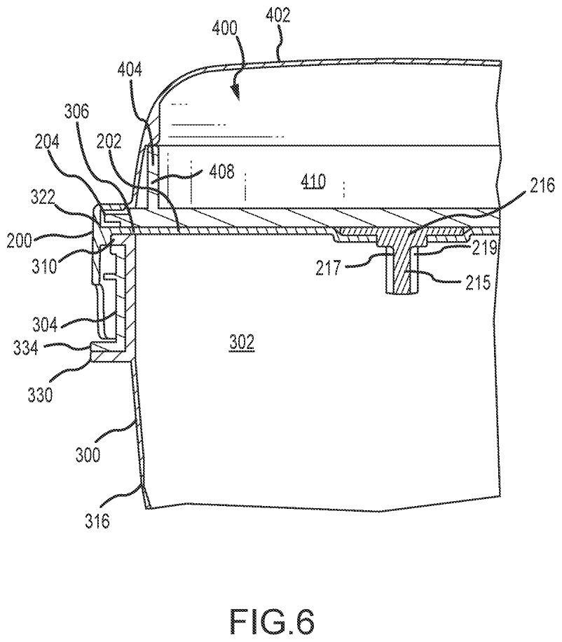

FIG. 6 depicts a cross-sectional area of example embodiment of the container 100. It may be seen that junction rail member 222 extends perpendicularly inward from junction member band portion 204. That junction rail member 222 may substantially surround half or less of the junction member 200, so that second compartment 400 may be slid into junction member 200.

Those of skill will understand that the example of coupling junction member 200 to second compartment 400 via junction rail member 222 is not intended to be limiting. In further embodiments, other methods of coupling junction member 200 to second compartment 400 are envisioned, as will be understood by one of skill in the art.

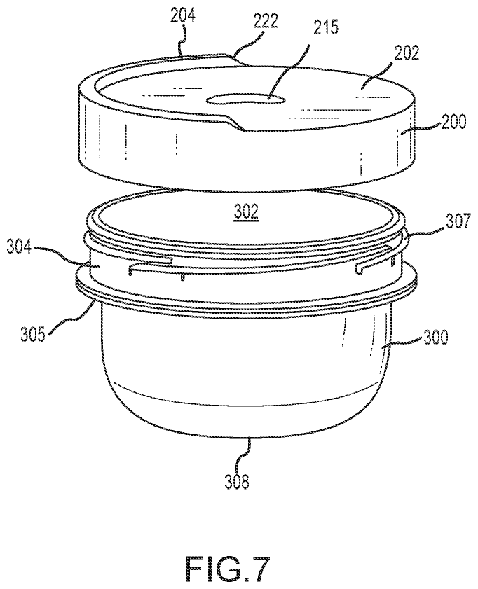

Turning to FIG. 7, first compartment 300 may be seen. First compartment 300 comprises a first compartment storage portion 302 made of silicone. First compartment storage portion 302 is a container with a mouth operable to be closed via coupling to junction member 200. In the example embodiment of container 100, first compartment storage portion 302 is substantially round with rounded edges in shape, with slight narrowing in the walls towards bottom end 308—the end that opposes the mouth end 306. In further embodiments, however, first compartment storage portion 302 may comprise any shape known to those of skill in the art.

In embodiments, first compartment storage portion 302 may comprise platinum silicone to provide a container with improved food safety. In embodiments, any other silicone component of container 100 may also comprise platinum silicone. Platinum silicone may help facilitate food safety certification, and it may help provide container 100 with a superior finish.

First compartment 300 further comprises a first compartment band 304 positioned around the mouth end of the first compartment storage portion 302. First compartment band 304 is formed from a material that is stiffer than the material comprising first compartment storage portion 302, and functions to provide rigidity around the mouth of first compartment 300, thereby providing structure to container 100. In embodiments, first compartment band 304 may be formed from plastic, composite, or bamboo. In further embodiments, first compartment band 304 may be formed from any material capable of providing additional stiffness to the mouth of first compartment 300. The junction member 200 engages the first compartment band 304 to form a lid thereon and provides means to seal the first compartment. In an embodiment, a mechanical means secures the junction member 200 to the first compartment band 304. The mechanical means may comprise at least one of snaps, levers, clasps, frictional fits, and threaded engagements. In the embodiment illustrated, threads 307 are shown on the first compartment band 304. The junction member 200 comprises mating threads (not visible) in this embodiment. When threaded together, the junction member 200 and first compartment band 304 are sealed such that a liquid placed in the first compartment 300 is securely contained therein.

In embodiments, first compartment band 304 may be positioned on an exterior surface of first compartment storage portion 302 to prevent first compartment band 304 from coming into contact with the contents stored within the first compartment 300. In embodiments, first compartment band 304 may be further coupled to first compartment storage portion 302 using an adhesive, such as a food-grade adhesive. In further embodiments, first compartment band 304 may be further coupled to first compartment storage portion 302 using any other method known in the art.

First compartment storage portion 302 is configured to be folded so that the entirety of the portion that extends below the first compartment band 304 fits within a volume defined by the of the first compartment band 304. In an alternate embodiment, only a majority of the portion that extends below the first compartment band 304 fits within a volume defined by the of the first compartment band 304. The first compartment storage portion 302 may comprise a pleat proximate a lower edge 305 of the first compartment band 304. By pleat, what is meant is two adjacent sections of a folded material connected via one angled bend in the material.

In embodiments, first container storage portion 300 further comprises an average thickness of silicon, with one or more regions of silicone being thinner than the average silicone thickness of first container storage portion 300. This allows first container storage portion 302 to form one or more predetermined pleats when pressure is applied to bottom end 308 of first container portion 300. In embodiments, one or more sections of silicone may comprise ring-shaped regions of thinner silicone arranged parallel to the periphery of the first compartment band 304.

In embodiments, first compartment storage portion 302 may comprise walls that have an average thickness that is between 1-4 mm. In further embodiments, however, first compartment storage portion 302 may have an average thickness that is between 2-3 mm. In embodiments, the one or more sections of silicone 316 that are thinner may be a fraction of a millimeter thinner than the average thickness. In embodiments, the one or more sections of silicone 316 may be 0.2-0.5 mm thinner, for example.

Those of skill will understand that, by using one or more sections of silicone 316 comprising ring-shaped regions of thinner silicon, it is possible to avoid the stepped profiles of prior art silicone containers. Prior art silicone containers use silicone having stepped profiles to facilitate folding that reduce the width of the container steeply to facilitate orderly silicone folding. The rapid narrowing of prior containers makes for a less room for storage, and a less aesthetically pleasing container to eat out of. Moreover, to avoid having the silicone dangle very far below the hard plastic covers when folded, prior art containers use a larger number of folds. Those of skill will readily understand that using one or more sections of silicone 316 comprising ring-shaped regions of thinner silicone allows container 100 to have fewer predetermined pleats, so that that the sides of the body of first container storage portion 302 will make the impression to the user as being predominantly vertical and smooth when unfolded.

In embodiments, the one or more sections of silicone 316 that are thinner than the average silicone thickness of first container storage portion 300 may be positioned on an interior surface of first container storage portion 302, as may best be seen in FIG. 6. This may allow the outside of first container storage portion 300 to provide a flush, smooth appearance.

In embodiments, mouth lip 310 of first compartment storage portion 302 may further comprise an annular ring portion 322. In embodiments, annular ring portion 322 may comprise a flat surface facing junction member 200 to provide a seal against junction member planar portion 202. In further embodiments, however, annular ring portion 322 may have a raised ridge to provide a seal against junction member planar portion 202.

In embodiments, first compartment storage portion 302 may further comprise a lower seat lip 330, wherein a distance between annular ring portion 322 and lower seat lip 330 may be configured to snuggly secure first compartment band portion 304 to first compartment storage portion 302 between annular ring portion 322 and lower seat lip 330. In embodiments, first compartment band 304 may further comprise a lower band lip 334 configured to seat against lower seat lip 330, thereby further preventing first compartment band 304 from moving up or down with respect to mouth lip 310. In embodiments, adhesive, for example a food grade adhesive, may be further used to couple first compartment band 304 securely to first compartment storage portion 302.

In embodiments, junction member planar portion 202 may further comprise a valve 215. The valve 215 may be opened, as shown in FIG. 5, thus allowing pressure equalization between the environment and the first compartment storage portion 302. The valve 215 comprises a valve member 216, stem 217 that engages a port 219 (see FIG. 6) formed by the junction member 200. In an embodiment, the stem 217 comprises a smaller diameter than the port 219, to allow air flow between the environment and the first compartment storage portion 302. In an embodiment, the stem 217 comprises a bore, slot, channel, or other passage that allows air flow between the environment and the first compartment storage portion 302 when the valve 215 is in the open position, as illustrated in FIG. 5. In the closed position, as illustrated in FIG. 6, the valve member 216 seals against the junction member 200 such that the first compartment storage portion 302 is sealed from the environment when the junction member 200 is securely engaged to the first compartment band 304. The valve 215 may be opened when microwaving contents of the first compartment 300 to prevent a build-up of pressure, for example.

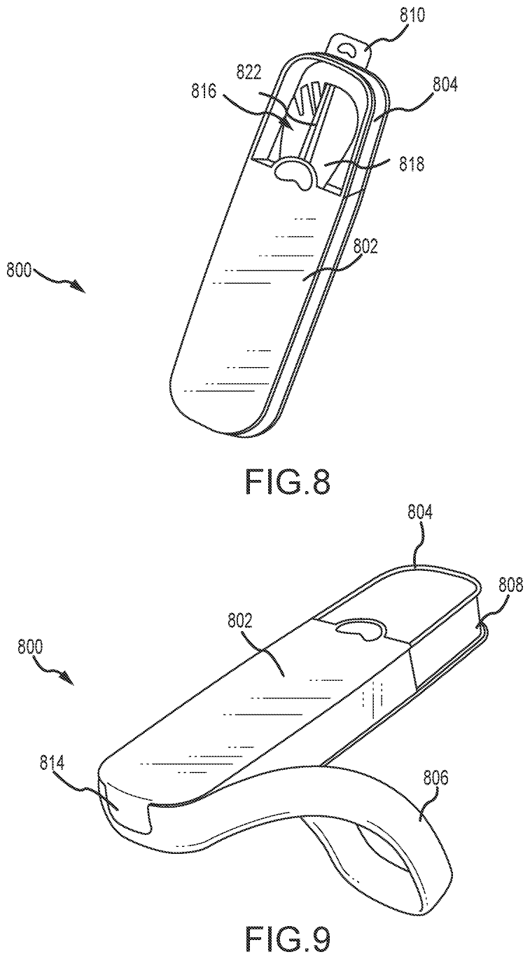

Turning to FIGS. 8-11, a tool container 800 is provided according to an embodiment. The tool container 800 may comprise a body portion 802 and a lid portion 804. An elastic member 806 is configured to secure the lid portion 804 to the body portion 802 when the tool container 800 is in a closed conformation. However, the lid portion 804 may instead or additionally snap into to the body portion 802 such that the lid portion 804 is secured to the body portion 802 until a user forcibly disengages the lid portion 804. This may be accomplished with a friction fit, with detents, with barbs, with a latch, or any other mechanical engagement means known in the art.

In an embodiment, the body portion 802 and a lid portion 804 each comprise a perimeter channel 808. The perimeter channel 808 provides a slot that captures the elastic member 806 such that the elastic member 806 cannot slide off the closed tool container 800 without being stretched out of the perimeter channel 808. In an embodiment, elastic member 806 comprises a tab 810 that allows the user to easily grasp the elastic member 806 and facilitate removal of the elastic member 806 from the perimeter channel 808.

An indentation 812 may be present in the elastic member 806 in some embodiments. The indentation 812 engages a similarly shaped boss 814 formed on the body portion 802. When the indentation 812 engages the boss 814, this further aids in securing the elastic member 806 in the perimeter channel 808, and also aligns the elastic member 806 so that the tab 810 is located proximate a distal region of the lid portion 804.

The tool container 800 is configured to hold tools 816. In an embodiment, the tools are dining utensils. Depending on the intended use of the container, other varieties of tools may instead be present. In embodiments, one or more tools 816 may comprise any combination of fork, spoon, spork, knife, spork, and/or chopsticks. In an embodiment, a primary tool 818 comprises an engagement region 820 configured to engage and secure one or more secondary tools 822.

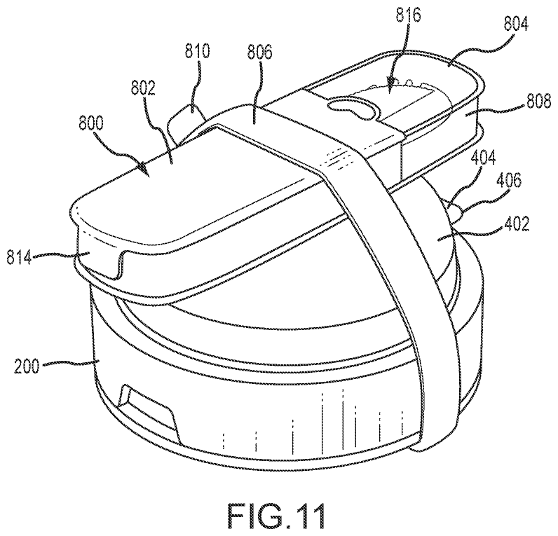

FIG. 11 illustrates the tool container 800 attached to the container 100 with the elastic member 806.

In embodiments, one or more tools 816 may be formed from any appropriate material known to those of skill. For example, one or more tools 816 may be formed from BPA-free polypropylene.

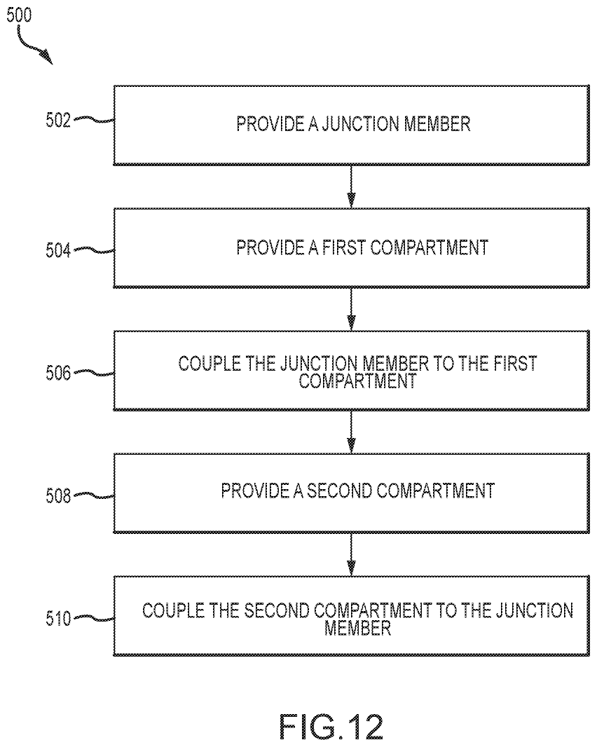

FIG. 12 depicts method 500, in accordance with an embodiment. Method 500 may be used to fabricate the container 100. Method 500 comprises steps 502 to 506.

In step 502, a junction member 200 is provided, as described above.

In step 504, a first compartment 300 is provided, as described above.

In step 506, junction member 200 is coupled to first compartment 300, as described above.

In embodiments, method 500 may further comprise steps 508 and 510. In step 508, a second compartment 300 may be provided, as described above.

In step 510, second compartment 400 may be coupled to the junction member 200, as described above.

The detailed descriptions of the above examples are not exhaustive descriptions of all examples contemplated by the inventors to be within the scope of the Application. Indeed, persons skilled in the art will recognize that certain elements of the above-described examples may variously be combined or eliminated to create further examples, and such further examples fall within the scope and teachings of the Application. It will also be apparent to those of ordinary skill in the art that the above-described examples may be combined in whole or in part to create additional examples within the scope and teachings of the Application. Accordingly, the scope of the Application should be determined from the following claims.

What is claimed is:

1. A container (100) comprising:
a junction member (200) comprising a junction member planar portion (202) surrounded on a periphery by a junction member band portion (204), the junction member band portion (204) comprising a junction member rail (222) projecting from the junction member band portion (204);
a first compartment (300) comprising a first compartment storage portion (302) comprising silicone with a mouth end (306) and a bottom end (308), and a first compartment band (304) positioned around the mouth end (306) of the first compartment storage portion (302), wherein the mouth end (306) comprises a mouth lip (310) configured to be sealingly retained between the junction member planar portion (202) and the first compartment band (304), and wherein the first compartment storage portion (302) is configured to be folded about one or more thin sections of silicone (316) such that the first compartment (300) fits within a volume of the junction member band portion (204) when the first compartment (300) is coupled to the junction member (200);
a second compartment (400) comprising a lid (402) and a base (404), wherein the second compartment (400) is slidingly couplable to the junction member (200), and wherein the second compartment (400) is couplable to the junction member rail (222).

2. The container (100) as claimed in claim 1, wherein the lid (402) wraps around the edge of the base (404).

3. The container (100) as claimed in claim 1, wherein the junction member rail (222) frictionally engages both the lid (402) and the base (404) of the second compartment (400) to couple the second compartment (400) to the junction member (200).

4. The container (100) as claimed in claim 1, wherein the lid (402) of the second compartment (400) is configured to be removable from the base (404), and is further configured for use as a bowl.

5. The container (100) as claimed in claim 1, wherein the first compartment band (304) is couplable to the junction member (200).

6. The container (100) as claimed in claim 5, wherein the first compartment band (304) is formed from a material that is stiffer than the first compartment storage portion (302).

7. The container (100) as claimed in claim 5, wherein the first compartment band (304) is threadingly couplable to the junction member (200).

8. The container (100) as claimed in claim 1, wherein the junction member (200) comprises a valve (215) configured to be in an open and closed position, wherein the valve (215) allows allowing pressure equalization between the first compartment storage portion (302) and an external environment when in the open position.

9. A tool container (800) configured to hold tools (816) comprising:
a body portion (802);
a lid portion (804) engagable to the body portion (802);
an elastic member (806) configured to secure the lid portion (804) to the body portion (802);
wherein the body portion (802) and the lid portion (804) each comprise a perimeter channel (808) that provides a slot that captures the elastic member (806) such that the elastic member (806) cannot slide off the closed tool container (800) without being stretched out of the perimeter channel (808).

10. The tool container (800) as claimed in claim 9, wherein the tools (816) comprise a primary tool (818) and one or more secondary tools (822), wherein the primary tool (818) further comprises an engagement region (820) configured to engage and secure one or more secondary tools (822) thereto.

11. The tool container (800) as claimed in claim 9, wherein the elastic member (806) comprises a size and dimension such that it is configured to attach the tool container (800) to the container (100) claimed in claim 1 by wrapping around both the tool container (800) and the container (100).

12. The tool container (800) as claimed in claim 9, wherein the primary tool (818) comprises at least one of a fork, spoon, knife, and a spork, and the one or more secondary tools (822) comprises at least one of a fork, spoon, knife, spork, and chopsticks.

13. The tool container (800) as claimed in claim 9, wherein the elastic member (806) comprises an indentation (812), and the body portion (802) comprises a boss (814) engageable to the indentation to aid in securing the elastic member (806) in the perimeter channel (808).

14. A method to fabricate a container (100) according to claim 1, the method comprising:
providing the junction member (200) comprising the junction member planar portion (202) surrounded on the periphery by the junction member band portion (204), the junction member band portion (204) further comprising the junction member rail (222) projecting from the junction member band portion (204);
providing the first compartment (300) comprising the first compartment storage portion (302) comprising silicone with the mouth end (306) and the bottom end (308), and the first compartment band (304) positioned around the mouth end (306) of the first compartment storage portion (302), wherein the mouth end (306) comprises the mouth lip (310) configured to be sealingly retained between the junction member planar portion (202) and the first compartment band (304), and wherein the first compartment storage portion (302) being is configured to be folded about one or more thin sections of silicone (316) such that the first compartment (300) fits within a volume of the junction member band portion (204) when the first compartment (300) is couplable to the junction member (200);
coupling the junction member (200) and the first compartment (300) together.

15. A method as claimed in claim 14, further comprising:
providing a second compartment (400) comprising a lid (402) and a base (404);
slidingly coupling the second compartment (400) to the junction member (200).

16. A method as claimed in claim 14, further comprising:
providing tool container (800) configured to hold tools (816) comprising:
a body portion (802);
a lid portion (804) engageable to the body portion (802);
an elastic member (806) configured to secure the lid portion (804) to the body portion (802); and
wherein the body portion (802) and the lid portion (804) each comprise a perimeter channel (808) that provides a slot that captures the elastic member (806) such that the elastic member (806) cannot slide off the closed tool container (800) without being stretched out of the perimeter channel (808);
providing a container comprising:
a junction member (200) comprising a junction member planar Portion (202) surrounded on a periphery by a junction member band portion (204), the junction member band portion (204) comprising a junction member rail (222) projecting from the junction member band portion (204);
a first compartment (300) comprising a first compartment storage portion (302) comprising silicone with a mouth end (306) and a bottom end (308), and a first compartment band (304) positioned around the mouth end (306) of the first compartment storage portion (302), wherein the mouth end (306) comprises a mouth lip (310) configured to be sealingly retained between the junction member planar portion (202) and the first compartment band (304), and wherein the first compartment storage portion (302) is configured to be folded about one or more thin sections of silicone (316) such that the first compartment (300) fits within a volume of the junction member band portion (204) when the first compartment (300) is coupled to the junction member (200); and
a second compartment (400) comprising a lid (402) and a base (404), wherein the second compartment (400) is slidingly couplable to the junction member (200), and wherein the second compartment (400) is couplable to the junction member rail (222); and
attaching the tool container (800) to the container (100) with the elastic member (806).
